(19) United States
(12) Patent Application Publication
(10) Pub. No.: US 2010/0134459 A1
(43) Pub. Date: Jun. 3, 2010

(54) FLAT DISPLAY DEVICE

(76) Inventor: Toyoshi Kawada, Kunitomi (JP)

Correspondence Address: MCDERMOTT WILL & EMERY LLP, 600 13TH STREET, N.W., WASHINGTON, DC, 20005-3096, US

(21) Appl. No.: 11/993,815

(22) PCT Filed: Jul. 12, 2005
(86) PCT No.: PCT/JP2005/012839

§ 371 Date: Dec. 21, 2007

(51) Int. Cl. G09G 5/00

(52) U.S. Cl. 345/211; 345/60

(57) ABSTRACT

A technology is provided for suppressing the occurrence of problems due to positional shift caused by temperature increase of a panel and a chassis, in a structure for mounting a driver IC chip and a driver module in a flat display device. The plasma display device is provided with a chassis section (63) arranged close to a panel (PDP) (64) and a rear surface side thereof; and a WB-ADM (address driver module) (61) having a flexible substrate (41) whereupon the driver IC chip (in a sealing resin (45)) for driving an electrode of the panel (64) is mounted by WB (wire bonding) method. The plasma display device is also provided with a buffer member (62) attached to the chassis section (63) to have a sliding mechanism and for fixing the WB-ADM (61).

### TECHNICAL FIELD

The present invention relates to a technology for a flat display device using a flat display panel such as a plasma display panel (PDP). In particular, it relates to a mounting structure of a driver IC chip for driving electrodes of the panel and a driver IC chip mounting module provided with the driver IC chip (hereinafter, referred to as a driver module and others).

### BACKGROUND ART

Recent progress in development and practical application of a display device using a flat display panel has been remarkable. In particular, an AC-type PDP with a three-electrode-type surface discharge structure has been actively used and applied to a wide-screen TV and the like because of its ease of the screen size increase and the colorization.

As a driver module for driving a PDP, instead of a conventional wire-bonding (hereinafter, referred to as WB) driver module, a gang-bonding (hereinafter, referred to as GB) driver module has been developed, in which higher-density mounting is possible with the aim of size reduction and cost reduction and also an increase in productivity can be expected. Incidentally, a module in which one or more driver IC chips are integrated as a module on a flexible substrate is referred to as a driver module. For example, a driver module for driving an address electrode is referred to as an address driver module (ADM). In particular, an ADM of a WB method is referred to as WB-ADM and an ADM of a GB method is referred to as GB-ADM.

An example of the mounting structure of the driver module in the flat display device is disclosed in Patent Document 1.

### Patent Document 1: Japanese Patent Application Laid-Open Publication No. 2001-352022.

### DISCLOSURE OF THE INVENTION

### Problem to be Solved by the Invention

A flat display device having a driver module such as above-described WB-ADM or GB-ADM has following problems resulting from the circuit power-distribution operation.

FIG. 17 is an explanatory diagram showing the problem in a configuration example of a flat display device having a module in which WB-ADM 61 is incorporated. At the same time of switching from a power-off state to a power-on state, the temperature of a panel 64 and a circuit begins to increase along with the power consumption. Note that dotted lines connecting the panel 64 side and an aluminum plate 42 side represent flexible substrates 41. The upper side and the lower side of FIG. 17 show the positional relationships of each component in the power-off state and the power-on state, respectively. Note that the chassis section 63 includes chassis accessories and the like.

Thermal expansion of the panel 64 and the chassis section 63 begins along with the above-described temperature increase, and positional shift occurs therebetween due to the difference in thermal expansion coefficient between the materials thereof. The panel 64 (glass material) has a smaller coefficient than that of the chassis section 63 (aluminum material). As described on the lower side of FIG. 17, due to the thermal expansion, the positional shift occurs mainly in a panel surface horizontal direction shown by arrows. Since the aluminum plate 42 of the WB-ADM 61 is connected and fixed to the chassis section 63, the shift occurs also between the WB-ADM 61 and the panel 64 in accordance with the positional shift between the panel 64 and the chassis section 63, and distortion occurs in the flexible substrate 41.

For example, a general thermal expansion coefficient of glass used as a panel material is 8.3×10⁻⁶ (1/K). On the other hand, an aluminum plate material which is light and has good thermal conductivity is often used for the chassis, and the thermal expansion coefficient thereof is 23.1×10⁻⁶ (1/K). Since there is a difference that the coefficient of the chassis is larger by about 2.8 times, the positional shift reaches a significant level particularly in a large-size flat display device.

As shown in the lower part of FIG. 17, due to the positional shift between the panel 64 and the chassis section 63, undesirable stress is applied as distortion particularly to the flexible substrate 41. Such state is repeated by power on/off, and as a result, fatigue disconnection may occur in a copper foil wiring pattern in the flexible substrate 41.

Next, FIG. 18 is an explanatory diagram showing the problem in a configuration example of a flat display device having a module in which GB-ADM 71 is incorporated, in the same manner as that of FIG. 17. The GB-ADM 71 is held by a holding plate 75 to a similar panel 74 and chassis section 73, and a driver IC chip 56 of the GB-ADM 71 is fixed so as to be in contact with the surface of the chassis section 73.

In this case, an undesirable force in a horizontal direction of the panel 74 surface, that is, a peeling force to the driver IC chip 56 is applied to the driver IC chip 56 held on the side of the chassis section 73. Similar to the case of the WB-ADM 61, such state is repeated by power on/off, and as a result, the driver IC chip 56 is peeled off in some cases.

The present invention has been devised in view of the problems described above, and an object of the present invention is to provide a technology capable of obtaining good thermal and electrical performance and stable quality in terms of long-term reliability so as to prevent the occurrence of failure due to positional shift and the like caused by the temperature increase in a set of a panel and a chassis, in relation to a mounting structure of a driver IC chip and a driver module on a panel such as a PDP in a flat display device as described above.

### Means for Solving the Problems

The typical ones of the inventions disclosed in this application will be briefly described as follows. To achieve the above-described object, the flat display device according to the present invention includes a mounting structure of a driver IC chip and a driver module on a panel such as a PDP and is characterized by having the following technical means and mounting structure.

In this flat display device, as a mounting structure of a driver IC chip and a driver module on a panel such as a PDP, a buffer member having a mechanism and a characteristic movable with respect to the chassis section is provided between the chassis section and the driver module as means for buffering the influence of positional shift between the panel and the chassis section and the like. By this means, thermal and electric characteristics are improved. In particular, a structure in which the driver module is fixed to the buffer member or a structure in which the driver IC chip of the driver module is directly or indirectly in contact with the buffer member is provided. Details thereof will be described below.

(1) The device of the present invention includes: a flat display panel (hereinafter, referred to as an FDP) having electrodes, for example, display electrodes (X, Y) and an address electrode (A); a driver module having a flexible substrate on which a driver IC chip (semiconductor integrated circuit component) connected to the electrodes of the FDP to drive the electrodes is mounted; a chassis section provided near a rear surface side of the FDP; and a buffer member formed separately from the chassis section and attached so as to be movable with respect to the chassis section (which is a member for buffering the connection between the driver module and the chassis section and can be also referred to as a movable member or the like). Also, the input/output terminals of the driver module are connected to the FDP and the data bus substrate on a chassis side, and further the driver module itself is fixed to the buffer member. The chassis section includes, for example, a chassis (main body) having a chassis first surface and a chassis accessory connected and fixed thereto in an accompanying manner.

Further, a driver module having a flexible substrate on which a driver IC chip which drives the electrodes of the FDP is mounted by a WB method and a buffer member attached to be movable with respect to the chassis section and attached so as to have thermal conductivity to the chassis section side are provided. The driver module is fixed to the buffer member by an aluminum plate and screw fixing thereof or the like. On the side of a circuit formation surface of the driver IC chip, that is, the surface opposite to the chassis section side, the buffer member is disposed with a distance interposed therebetween.

Moreover, the buffer member is provided with a sliding mechanism with respect to a second surface of the chassis section, for example, the surface of the device rear surface side (opposite surface of the first surface), and is attached so as to slide mainly in the horizontal direction of the second surface of the chassis section and also to be movable in the vertical direction. For example, the surface of the buffer member is disposed so as to be in contact with and slide on the chassis surface. In particular, the buffer member is attached to the chassis section particularly by a flexible adhesive. Furthermore, the buffer member is attached to have thermal conductivity to the chassis section. Also, in designing of the thermal expansion coefficients of the FDP, the chassis section, and the buffer member, they are configured so that the FDP and the buffer member have close values of coefficients.

(2) Another device of the present invention includes: a FDP having electrodes; a driver module having a flexible substrate on which a driver IC chip connected to the electrodes of the FDP to drive the electrodes is mounted by a GB method; a chassis section provided adjacent to the rear surface side of the FDP; and a holding plate (fixing member) which interposes the driver IC chip between itself and a part of the chassis section to fix the driver IC chip. Further, a buffer member which is formed separately from the chassis section and the holding plate is disposed on a non-circuit-formation surface of the driver IC chip (that is, a surface opposite to the chassis section side) so as to be in direct or indirect contact with the same.

Particularly, a buffer member attached so as to be movable with respect to the chassis section and having thermal conductivity to the chassis section side is provided. The driver module is held by the holding plate, and the driver module is fixed between the holding plate and the chassis section with interposing the buffer member therebetween. Particularly, the buffer member is disposed so as to be movable with respect to the chassis section and the holding plate (or driver IC chip and others). Also, the buffer member is disposed to have a sliding mechanism with respect to the chassis section and the holding plate. Further, the buffer member is attached to the chassis section and the holding plate by a flexible adhesive. Moreover, the buffer member is attached so as to have thermal conductivity by, for example, interposing a thermally conductive member with respect to the chassis section and the holding plate. Furthermore, in designing of the thermal expansion coefficients of the FDP, the chassis section, and the buffer member, they are configured so that the FDP and the buffer member have close values of coefficients. Moreover, in above-described (1) and (2), the FDP is a plasma display panel, and the driver module is an address driver module for driving an address electrode of the electrodes of the plasma display panel.

### EFFECT OF THE INVENTION

The effects obtained by typical aspects of the present invention will be briefly described below. According to the present invention, in the flat display device, as a mounting structure of the driver IC chip for driving the electrode of the panel, failure occurrence due to positional shift or the like caused by the temperature increase in the set of the panel and the chassis can be suppressed, and excellent thermal and electrical performance can be achieved, and quality stable in terms of long-term reliability can be obtained. Moreover, the low-cost and high-density mounting excellent in heat dissipation performance can be realized.

### BRIEF DESCRIPTION OF THE DRAWINGS

FIG. 1 is a cross-sectional schematic configuration diagram of a flat display device according to an embodiment of the present invention and a prior-art technology;

FIG. 2 is a perspective view showing a part of the configuration of a three-electrode surface-discharge AC type PDP in the flat display device according to the embodiment of the present invention and the prior-art technology;

FIG. 3 is a block diagram showing a configuration of a panel electrode and a drive circuit in the flat display device according to the embodiment of the present invention and the prior-art technology;

FIG. 4 is an explanatory diagram showing an external view on a rear surface side of a PDP module in the flat display device according to the embodiment of the present invention and the prior-art technology;

FIG. 5 is an explanatory diagram showing an exemplary configuration of a WB-ADM in the flat display device according to the first embodiment of the present invention and the prior-art technology;

FIG. 6 is an explanatory diagram showing the configuration of main components and principle in relation to a solution of the problem in the prior-art technology, in the mounting structure of the flat display device according to the first embodiment of the present invention;

FIG. 7A is an explanatory diagram showing the principle in each driver module in an enlarged manner in the flat display device according to the first embodiment of the present invention;

FIG. 7B is an explanatory diagram showing the principle in each driver module in an enlarged manner in the flat display device according to the first embodiment of the present invention;

FIG. 7C is an explanatory diagram showing the principle in each driver module in an enlarged manner in the flat display device according to the first embodiment of the present invention;

FIG. 8A is an external perspective view seen from a rear surface side of a panel, showing a specific mounting structure of the flat display device according to the first embodiment of the present invention;

FIG. 8B is a cross-sectional view in a longitudinal direction of the panel corresponding to FIG. 8A;

FIG. 9 is an explanatory diagram showing a configuration of a buffer plate in the mounting structure in the flat display device according to the first embodiment of the present invention;

FIG. 10 is an explanatory diagram showing a configuration example of a GB-ADM in a flat display device according to the second and third embodiments of the present invention and the prior-art technology;

FIG. 11 is an explanatory diagram showing the configuration of main components and principle in relation to a solution of the problem in the prior-art technology, in the mounting structure of the flat display device according to the second embodiment of the present invention;

FIG. 12A is an external perspective view seen from a rear surface side of a panel, showing a specific mounting structure of the flat display device before device assembling according to the second embodiment of the present invention;

FIG. 12B is a cross-sectional view in a longitudinal direction of the panel corresponding to FIG. 12A;

FIG. 13A is an external perspective view seen from a rear surface side of a panel, showing a specific mounting structure of the flat display device after device assembling according to the second embodiment of the present invention;

FIG. 13B is a cross-sectional view in a longitudinal direction of the panel corresponding to FIG. 13A;

FIG. 14 is an explanatory diagram showing a configuration of a buffer plate in a mounting structure in the flat display device according to the second and third embodiments of the present invention;

FIG. 15A is an external perspective view seen from a rear surface side of a panel, showing a specific mounting structure of the flat display device before device assembling according to the third embodiment of the present invention;

FIG. 15B is a cross-sectional view in a longitudinal direction of the panel corresponding to FIG. 15A;

FIG. 16A is an external perspective view seen from a rear surface side of a panel, showing a specific mounting structure of the flat display device after device assembling according to the third embodiment of the present invention;

FIG. 16B is a cross-sectional view in a longitudinal direction of the panel corresponding to FIG. 16A;

FIG. 17 is an explanatory diagram showing a problem caused in the case of a WB-ADM in a flat display device in a prior-art technology of the present invention; and

FIG. 18 is an explanatory diagram showing a problem caused in the case of a GB-ADM in a flat display device in a prior-art technology of the present invention.

### BEST MODE FOR CARRYING OUT THE INVENTION

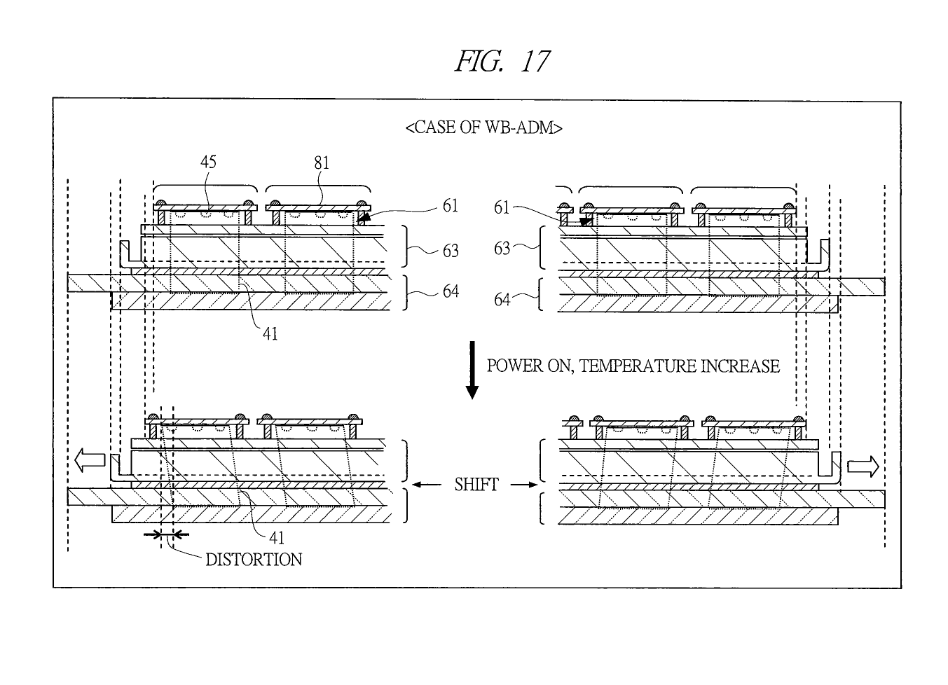

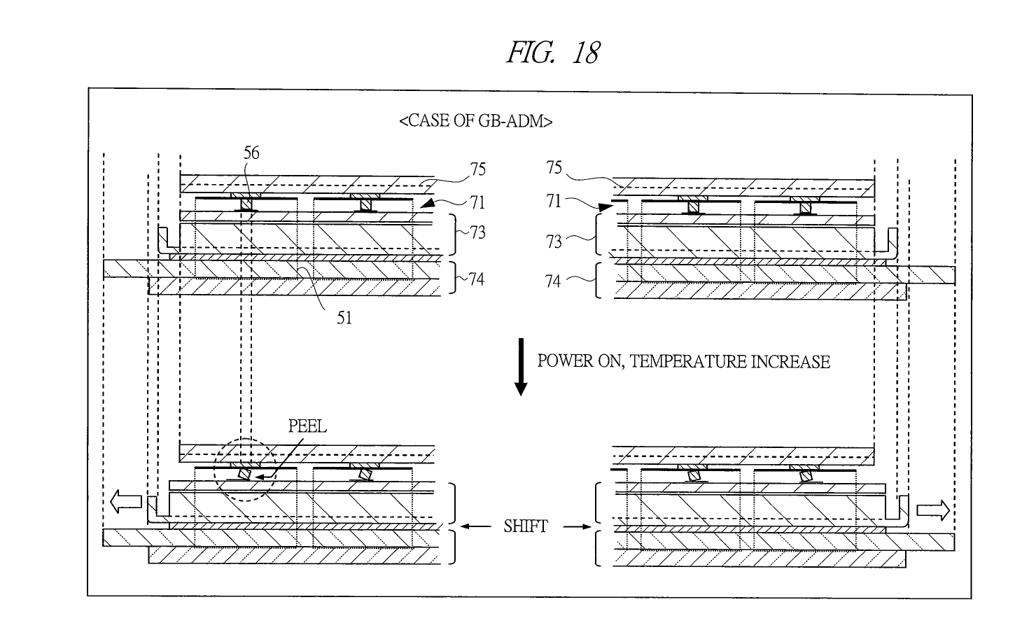

Hereinafter, embodiments of the present invention will be described in detail with reference to the accompanying drawings. Note that components having the same function are denoted by the same reference symbols throughout the drawings for describing the embodiment, and the repetitive description thereof will be omitted. FIG. 1 to FIG. 16 are diagrams for describing the embodiments. FIG. 17 and FIG. 18 are drawings for describing the configuration of a prior-art technology for comparison with the embodiments of the present invention.

<Outline>

A flat display device in each of the embodiments of the present invention is a plasma display device having a PDP as a flat display panel. In this device, for the PDP, a chassis section, and a driver module, a buffer member having a sliding mechanism with respect to the chassis section is provided between the chassis section and the driver module as means for buffering the influence of the positional shift between the PDP and the chassis section due to the temperature increase.

<Configuration of Prior-Art Technology>

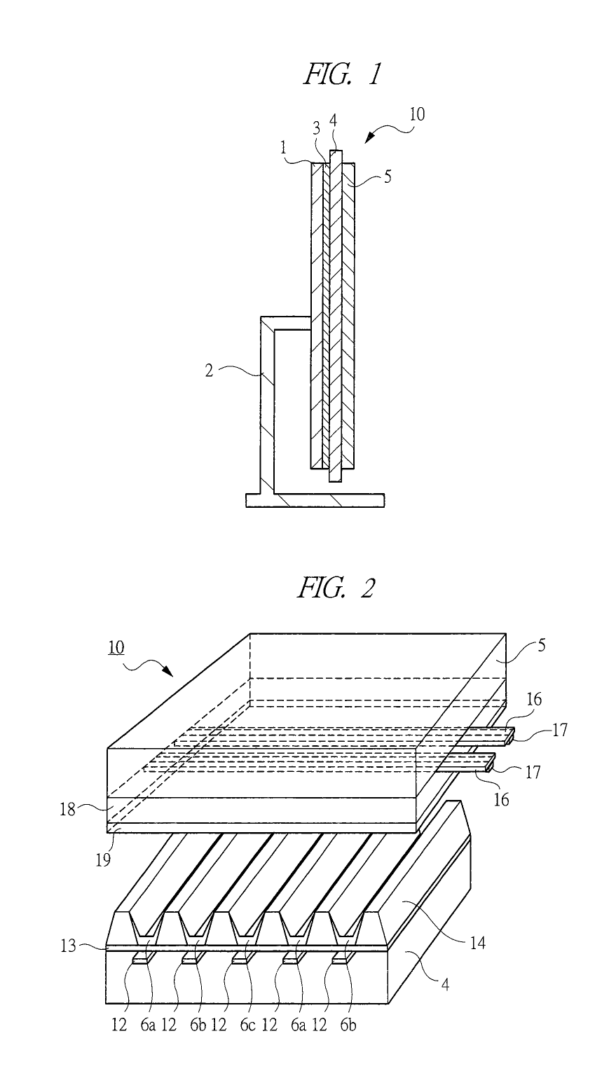

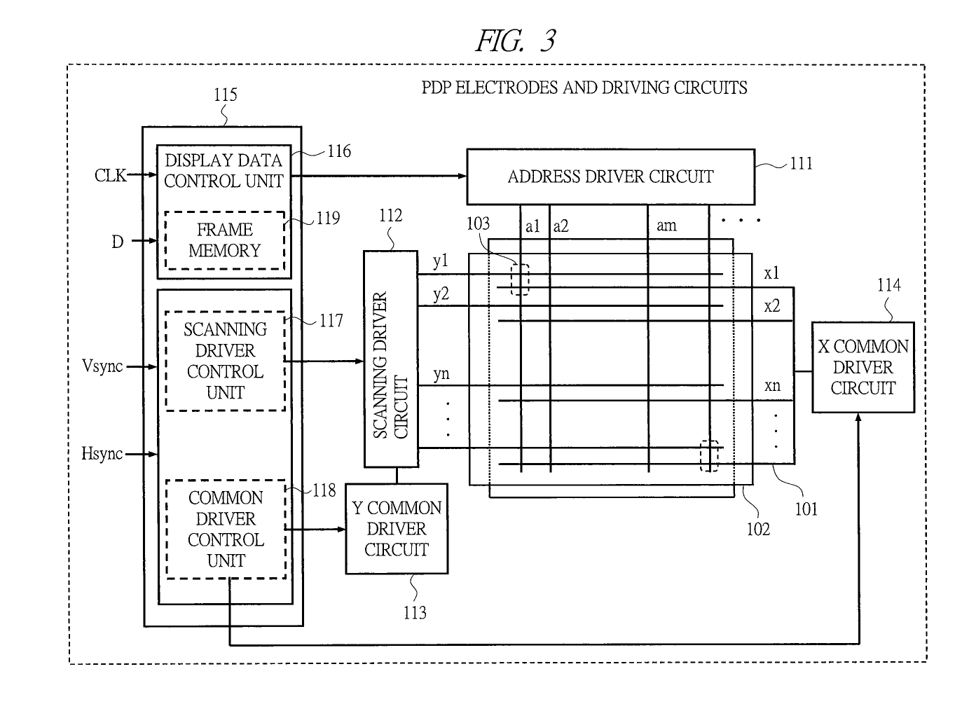

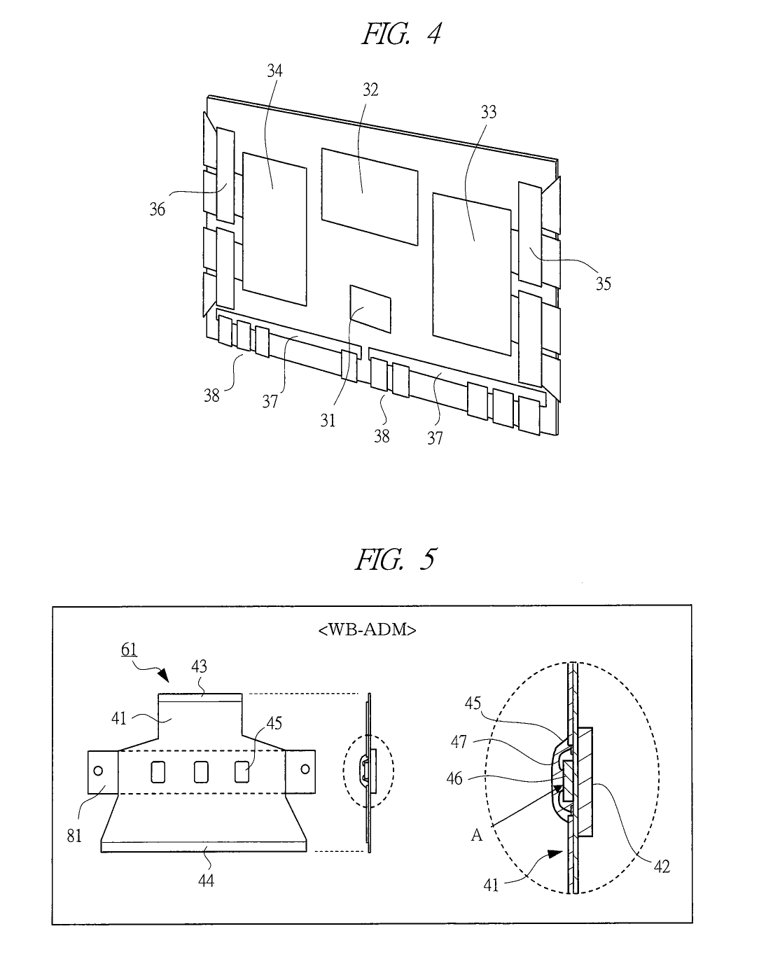

First, for the purpose of comparison with the present embodiments, the configuration of a prior-art technology of the present invention will be described. FIG. 1 is a schematic cross-sectional view in a longitudinal direction of a panel, showing the configuration of a flat display device to which an AC-type PDP panel (or simply referred to as PDP or panel) with three-electrode surface discharge structure is applied (that is, plasma display device) according to the prior-art technology and the embodiments of the present invention. FIG. 2 is a perspective view showing a part of a configuration corresponding to cells of a PDP 10 of the device. FIG. 3 is a block diagram showing the configuration of electrodes of the PDP 10 and main portions in driving circuits for performing a display operation of the PDP in the device. FIG. 4 is an external view of a PDP module seen from a rear surface side thereof, in which a driving circuit and the like are incorporated on a rear surface side of the PDP 10.

<Plasma Display Device>

In FIG. 1, the plasma display device includes the PDP 10, a chassis 1 and others. The PDP 10 is mainly formed of two substrates, that is, a front-surface glass substrate 5 and a rear-surface glass substrate 4, and the PDP 10 is connected and fixed to the chassis 1 by an adhesive 3. The chassis 1 and the PDP 10 are supported by a stand 2 and others.

In FIG. 2, in the PDP 10, the front-surface glass substrate 5 includes an X electrode as a first electrode and a Y electrode as a second electrode. Each of the X and Y electrodes is configured of a BUS electrode (metal electrode) 17 to be a sustain electrode and a transparent electrode 16. For example, the Y electrode functions as a scanning electrode. The X and Y electrodes are covered with a dielectric layer 18 and a protective layer 19. Also, on the rear-surface glass substrate 4, an address electrode (A) 12 as the third electrode is disposed so as to be orthogonal to the sustain electrodes (X, Y). The address electrode 12 is covered with a dielectric layer 13. With these electrodes (X, Y, A), each display cell that generates discharge light emission is formed at an area intersecting with the address electrode 12 in an area interposed between the electrodes of the respective reference numerals of the sustain electrodes (X, Y).

A plurality of ribs (barrier rib) 14 for forming the areas partitioned into a stripe shape in a longitudinal direction are formed between the front-surface glass substrate 5 and the rear-surface glass substrate 4. In the area partitioned by the ribs 14, phosphors 6 (6a, 6b, 6c) for each of the colors R, G, and B are applied. Each pixel is formed from the display cells of the respective colors. Note that the structure where the ribs are disposed in a lateral direction is also possible.

<Driving Circuit>

In FIG. 3, as to the driving circuits for the PDP 10 having the structure described above, driving circuits (drivers) such as a control circuit 115, an X-electrode driving circuit, a Y-electrode driving circuit, and an address-electrode driving circuit are provided on a front-surface substrate 101 and a rear-surface substrate 102 of the PDP 10.

The front-surface substrate 101 (corresponding to the above-described substrate 5) is provided with a plurality of X electrodes (Xn) as first electrodes and a plurality of Y electrodes (Yn) as second electrodes. The rear-surface substrate 102 (corresponding to the above-described substrate 4) is provided with a plurality of address electrodes (Am).

In this example, in particular, the control circuit 115 includes a display data control unit 116 having a frame memory 119 and driver control units. The driver control units include a scanning driver control unit 117 and a common driver control unit 118. Also, as the drivers, an address driver circuit 111, an X common driver circuit 114, a scanning driver circuit 112, and a Y common driver circuit 113 are provided.

The control circuit 115 generates control signals for controlling the respective drivers of the PDP 10 from externally-inputted interface signals {CLK (clock), D (data), Vsync (vertical synchronization), Hsync (horizontal synchronization)}, thereby controlling the respective drivers. Based on data signals stored in the frame memory 119, the address driver circuit 111 is controlled by the display data control unit 116. Also, the scanning driver circuit 112 is controlled by the scanning driver control unit 117. Furthermore, the X common driver circuit and the Y common driver circuit are controlled by the common driver control unit 118.

Each of the drivers drives the relevant electrodes in accordance with the control signal from the control circuit 115. On a display screen of the PDP 10, address discharge for determining display cells is performed by the driving from the address driver circuit 111 and the scanning driver circuit 112, and then sustain discharge for light emission of the display cells is performed by the driving from the X common driver circuit 114 and the Y common driver circuit 113.

In FIG. 4, as the circuits on the PDP module rear surface, for example, a logic circuit unit 31, a power-supply circuit unit 32, an X-SUS circuit unit 33, a Y-SUS circuit unit 34, an X-BUS circuit unit 35, an SDM circuit unit 36, data bus substrates 37, and address driver circuit units 38 are provided.

In the logic circuit unit 31, the control circuit 115 is mounted. The power-supply circuit unit 32 supplies power to each circuit unit based on inputted power. The X-SUS circuit unit 33 and the Y-SUS circuit unit 34 are circuits for the sustain discharge driving, and the common driver circuits are mounted therein. The X-SUS circuit unit 33 connects the X-BUS circuit unit 35 for relay. The Y-SUS circuit unit 34 connects the SDM circuit unit 36 corresponding to the scanning driver circuit 112. The data bus substrate 37 connects the plurality of address driver circuit units 38, and the address driver circuit unit 38 corresponds to ADM.

<Driver Module>

In the configuration of the driving circuits, for the scanning-side drivers and the address-side drivers, a circuit for selectively applying a driving pulse correspondingly to each electrode of the PDP 10 is required. In general, an element (driver IC chip) in which a circuit having such a function is integrated is used as a main circuit component. For example, an ADM in which a driver IC chip corresponding to the function of the address driver circuit 111 is mounted on a flexible substrate is used.

For example, in a PDP of a 42-inch class, 512 electrodes are disposed on the scanning electrode side, and 3072 electrodes for 1024 pixels (one pixel corresponds to three lines of RGB) are disposed on the address electrode side. It is required to connect the driving circuits correspondingly to each electrode.

Usually, in such a driver IC chip, circuits capable of driving 64 to 192 electrodes per IC are integrated in general. Therefore, eight driver ICs are used for 512 electrodes on the scanning electrode side, and 48 to 16 driver ICs are used for 3072 electrodes on the address electrode side.

In this manner, in order to incorporate many driver ICs as driving circuits in the PDP module, it is required to achieve a high-density mounting structure in which electrical connection to each of many electrodes can be surely made with high reliability and these circuits are compactly mounted so as to be reduced in size and thickness.

For this reason, as a connection mounting method for the driver IC chip to the flexible substrate, a gang-bonding (GB) method in which higher density mounting can be achieved and an increase in productivity can be expected has been increasingly adopted in place of a wire-bonding (WB) method conventionally prevailed in general.

Thus, in the GB method, with a technology of mounting a bear chip IC directly on the substrate, one or more driver IC chips are integrated as a module on a flexible substrate, and this module is incorporated in a display device.

<WB-ADM>

FIG. 5 shows a configuration example of a WB-type ADM (WB-ADM) as an example of a driver module in the prior-art technology (and the first embodiment). In FIG. 5, the developed surface of the flexible substrate 41 of the WB-ADM 61 seen from the rear-surface side of the PDP 10 and details of the driver IC chip mounting structure in the corresponding cross section of the WB-ADM 61 are shown.

The WB-ADM 61 has a structure in which the flexible substrate 41 on which electrical wiring is provided is attached to the aluminum plate 42 for holding and fixing the driver IC chip and heat dissipation, and one or more driver IC chips 46 covered with a sealing resin 45 are mounted on the surface of the flexible substrate 41. In the flexible substrate 41, an output terminal 44 extended to an end surface side for the connection to the PDP 10 and an input terminal 43 for the connection to the data bus substrate 37 side are provided.

In the flexible substrate 41, a copper foil pattern is formed on a base film, and in the WB type, pad terminals of outputs of the circuit formation surfaces of the driver IC chips 46 and corresponding terminals on the flexible substrate are connected to each other by wire connection (wire bonding) 47. The driver IC chip 46 and the wire connection 47 are covered with the sealing resin 45. On the flexible substrate 41, the output wiring connected to the output pad terminal of the driver IC chip 46 is connected for use to the electrodes of the PDP 10 via the output terminal 44 by, for example, thermocompression bonding.

The aluminum plate 42 is also used as a fixing plate for fixing the WB-ADM 61 to the chassis 1 side, and the circuit formation surface (A) side of the driver IC chip 46 is disposed so as to oppose to the rear surface side of the PDP 10 and the chassis 1.

In mounting of the WB-ADM 61 of the prior-art technology, the aluminum plate 42 is connected by screwing to fixing bosses (screw bearings) in an end area of the chassis 1 with interposing the flexible substrate 41 of the WB-ADM 61 therebetween. A certain distance is provided between the sealing resin 45 and the surface of the chassis 1.

<GB-ADM>

FIG. 10 shows a configuration example of a GB-type ADM (GB-ADM) as an example of a driver module of the prior-art technology (and second and third embodiments) in the same manner as that of FIG. 5.

In the GB method, the driver IC chip 56 is directly mounted on the surface of the flexible substrate 51 of the GB-ADM 71 which is a driver module. The flexible substrate 51 has an output terminal 54 for connection to the PDP 10 and an input terminal 53 for connection to the data bus substrate 37 side.

In mounting of the driver IC chip 56, the circuit formation surface (surface opposite to the flexible substrate 51) side thereof and corresponding terminals of the flexible substrate 51 side are connected by bumps 57. Ends of the driver IC chip 56 are covered with a sealing resin 55.

The non-circuit-formation surface (B) side of the driver IC chip 56 is disposed so as to be opposed to the rear surface side of the PDP 10 and the chassis 1.

### First Embodiment

The first embodiment will be described. A plasma display device of the first embodiment has a configuration comprising a PDP module including the WB-ADM 61, in which a buffer plate (buffer member 62) having a sliding mechanism with respect to the chassis section 63 is added between the chassis section 63 and the WB-ADM 61. The driver module applied in the first embodiment is similar to the above-described WB-ADM 61 shown in FIG. 5.

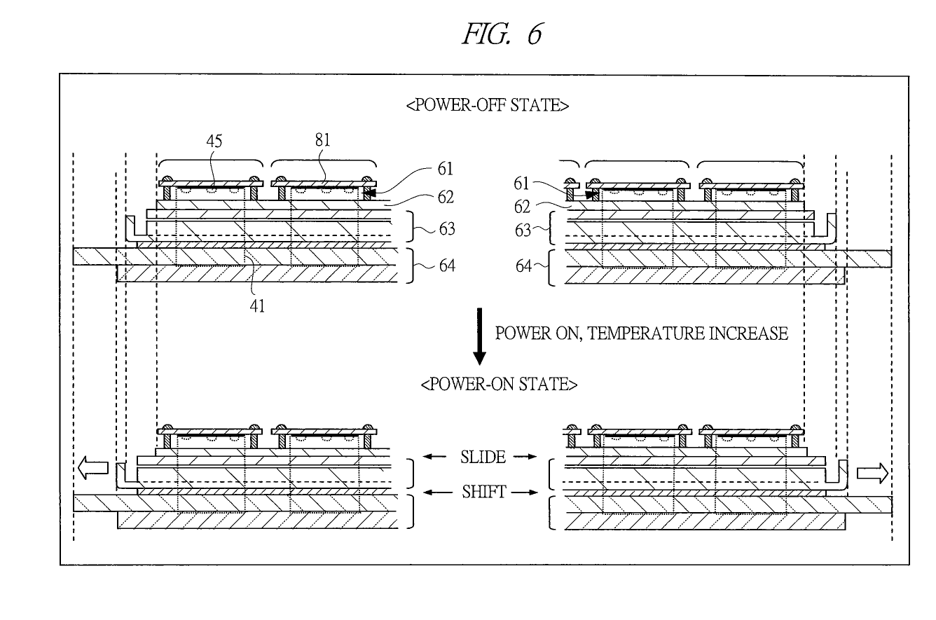

FIG. 6 is an explanatory diagram showing a cross section of a panel screen in a lateral direction for describing the configuration of main components and principle in relation to the solution of the problems (distortion stress caused by positional shift) resulting from the circuit power-distribution operation in the above-described prior-art technology, in the mounting structure of the plasma display device according to the first embodiment. Note that the illustration of the area around the center of the panel screen is omitted, and right and left ends of the panel are shown. The upper side of FIG. 6 shows a power-off state (that is, low-temperature state), and the lower side of FIG. 6 shows a power-on state and the state after temperature increase resulting from the circuit power-distribution operation (that is, high-temperature state).

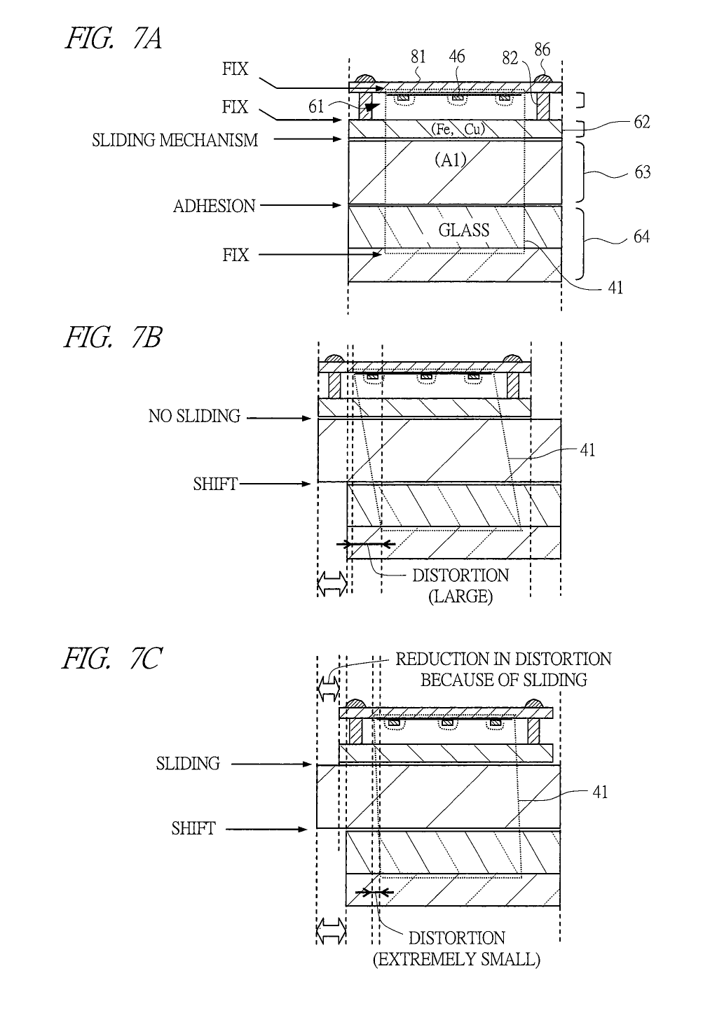

Also, FIG. 7A to FIG. 7C show the principle in each driver module in the case of the WB-ADM 61 of FIG. 6 in an enlarged manner, that is, the change in a positional relationship between constituent elements in the panel surface horizontal direction caused by the temperature change. FIG. 7A shows a power-off state and an ideal state. FIG. 7B shows the state in the case where it is assumed that sliding by the buffer member 62 is not provided in the power-on state. FIG. 7C shows the state where distortion is buffered by the sliding of the buffer member 62 in the power-on state.

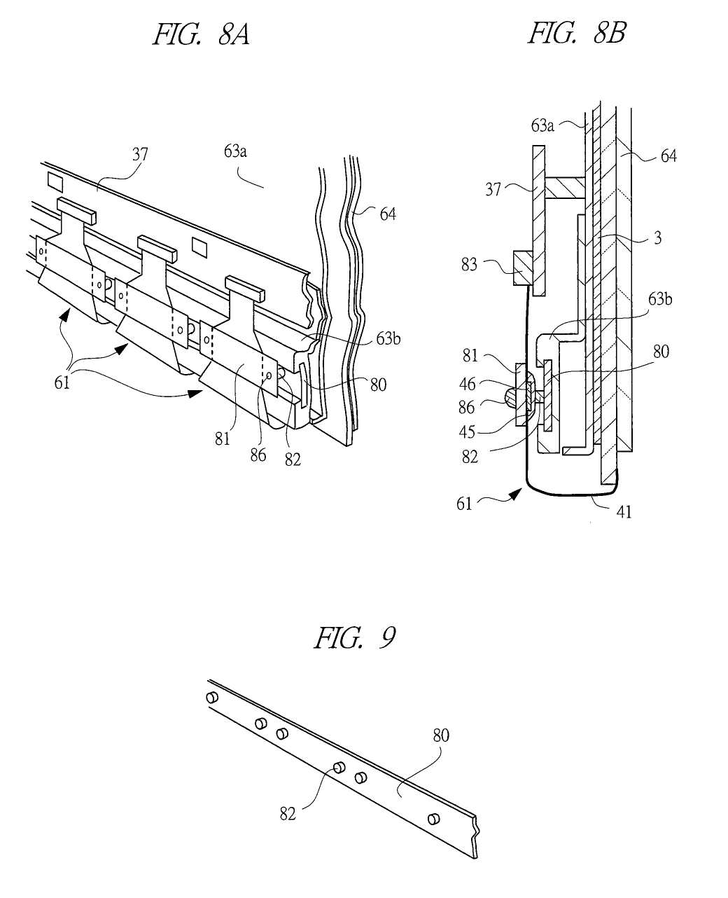

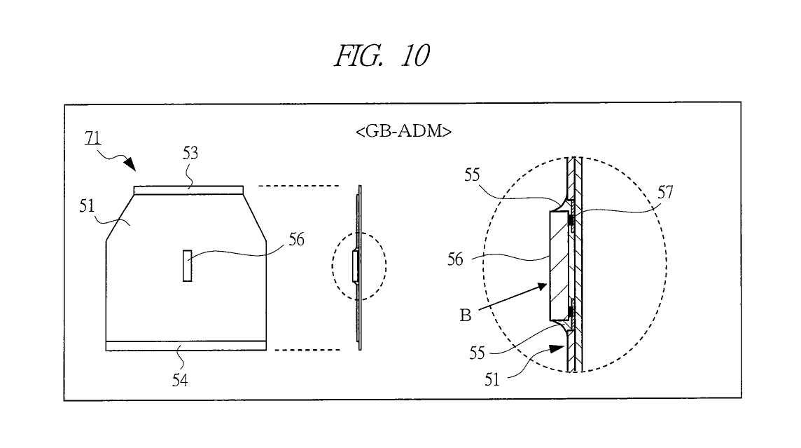

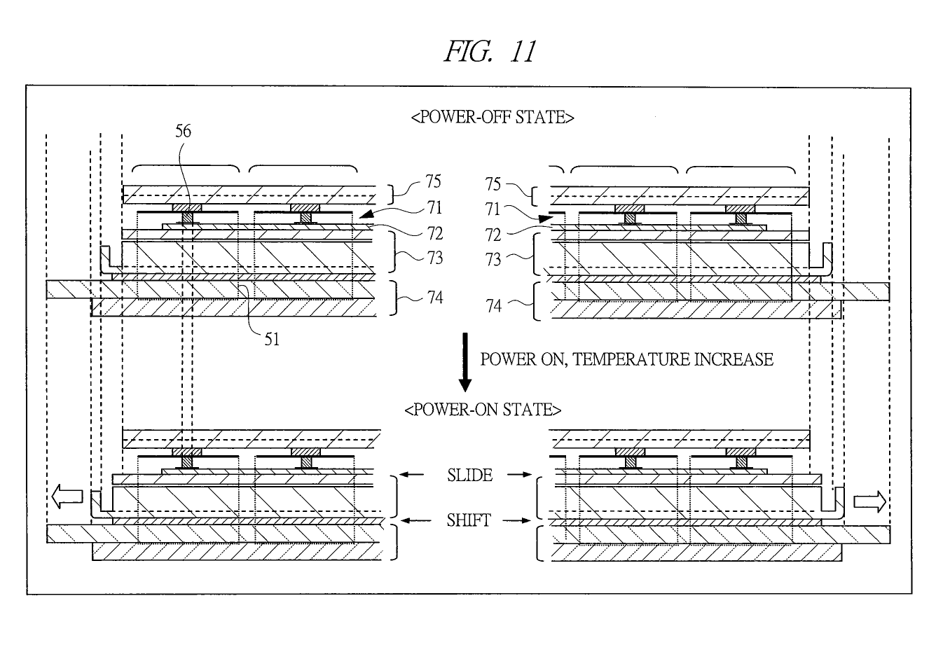

FIG. 8A and FIG. 8B show a further specified mounting structure in the first embodiment. FIG. 8A is an external perspective view of the mounting structure of the WB-ADM 61 seen from the panel rear surface side. FIG. 8B is a cross-sectional view in a longitudinal direction of the panel corresponding to FIG. 8A. FIG. 9 shows the configuration of a buffer plate 80 in the mounting structure of FIG. 8A and FIG. 8B.

In FIG. 6 and FIG. 7A and FIG. 7B, sequentially from the device front-surface side, the panel 64 (corresponding to the PDP 10), the chassis section 63, the buffer member 62, and the WB-ADM 61 are provided in this order. In this structure, the buffer member 62 is provided between the chassis section 63 and the plurality of WB-ADMs 61.

In the above-described prior-art technology, the WB-ADM 61 is directly fixed to the chassis section 63. On the other hand, in the first embodiment, the buffer member 62 which is fabricated separately from the chassis section 63 and attached to the chassis section 63 so as to be movable by a sliding mechanism or the like is provided. In this structure, the aluminum plate 42 of the WB-ADM 61 is fixed to the buffer member 62 as a fixing plate.

The principle of the first embodiment is as follows. With the temperature increase of the panel 64 and the circuit resulting from the circuit power-distribution operation, the temperature of the chassis section 63 also increases and the chassis section 63 thermally expands. The thermal expansion coefficient of the panel (glass material) 64 is smaller than the thermal expansion coefficient of the chassis section (aluminum material) 63. Thus, as shown by arrows, the positional shift that the surface of the chassis section 63 projects with respect to the surface of the panel 64 in the horizontal direction occurs. At this time, if sliding of the buffer member 62 is not provided as shown in FIG. 7B, the WB-ADM 61 projects together with the chassis section 63. Therefore, the distortion in the flexible substrate 41 is large. On the other hand, in the first embodiment, sliding occurs between the chassis section 63 and the buffer unit 62 as shown in FIG. 7C. Therefore, the amount of projection of the WB-ADM 61 pulled by the chassis section 63 is reduced. In other words, the stress due to the shift of the flexible substrate 41 is reduced, and the distortion can be significantly reduced.

Regarding the material of the constituent elements, for example, for the buffer member 62, iron: 11.8×10⁻⁶ (1/K) having a small thermal expansion coefficient about half of that of the aluminum material (material of the chassis section 63) or copper: 16.5×10⁻⁶ (1/K) is used. Alternatively, as various alloys other than that, nickel steel (50 alloy and the like): 9.4×10⁻⁶(1/K), stainless steel (SUS 430 and the like): 14.7×10⁻6 (1/K), aluminum alloy: 15.9×10⁻⁶ (1/K), brass: 17.5×10⁻⁶ (1/K) and the like are used. By this means, the positional shift and distortion between the WB-ADM 61 and the panel 64 can be suppressed to a small level, and the problem of the occurrence of the disconnection in the flexible substrate 41 can be solved. When any of these materials is used, regarding the relationship in the thermal expansion coefficient of the respective elements of the panel 64, the chassis section 63, and the buffer member 62, since the buffer member 62 is close to the panel 64 rather than the chassis section 63, a desirable relationship can be achieved.

Note that, as another specification, from the viewpoint of thermal expansion coefficient only, the distortion difference with respect to the panel 64 can be reduced by using a material such as iron having a thermal expansion coefficient close to that of the panel 64 rather than aluminum as the material of the chassis section 63. However, the thermal conductivity of the aluminum is roughly 240 ([W/m·K]), while the thermal conductivity of iron is roughly 25 to 80 ([W/m·K]), which is about one order of magnitude lower than that of aluminum. Therefore, the iron material has such defects that the heat dissipation characteristics with respect to the panel 64 are deteriorated and the weight per unit volume (density) is increased by about three times. Therefore, the iron material is difficult to be used as a material of the chassis section 63.

Further, in the case of a copper material having a thermal expansion coefficient smaller than that of aluminum, the thermal conductivity is roughly about 400 ([W/m·K]), which is rather better than aluminum. Therefore, there is no problem about heat dissipation. However, the copper material has such a defect that the weight per unit volume (density) is increased similarly to the iron material, and since the cost thereof is relatively high, which leads to the cost increase, the copper material is difficult to be used for a large-size device. Therefore, it is difficult to configure the entirety of the chassis section 63 from the copper material.

In the mounting structure of the first embodiment, in view of the above-described points, the materials of the constituent elements are selected in consideration of thermal expansion and thermal conductivity so that use of the materials having small thermal expansion coefficient is suppressed to a minimum level.

As shown in FIG. 8A and FIG. 8B, in this mounting structure, the buffer plate 80 serving as the buffer member 62 is provided. The buffer plate 80 is attached to a groove-shaped area in a part of a chassis accessory 63b so that it can be slid in/out with respect to a chassis structure including a chassis body 63a and the chassis accessory 63b. The attachment structure of the buffer plate 80 is merely an example, and another attachment structure can be employed. In addition to the sliding mechanism, the buffer plate 80 is attached so as to have thermal conductivity with respect to the chassis section 63. Heat is dissipated from the driver IC chip 46 to the aluminum plate 42, and the heat is dissipated from the aluminum plate 42 to the chassis section 63 side via the buffer member 62.

In a state where the flexible substrates 41 is bent, the plurality of WB-ADMs 61 are connected via the connection of the input terminals 43 of connectors 83 to the data bus substrate 37 connected to the chassis body 63a. Each of the plurality of WB-ADMs 61 is fixed by the aluminum plate 42 from the outside. In the aluminum plate 42, screw holes corresponding to fixing bosses 82 are formed at both ends thereof. The aluminum plate 42 is screwed by fixing screws 86 to the fixing bosses 82 of the buffer plate 80.

In the structure of this example, the buffer plate 80 which is the buffer member 62 is in contact with a partial area of the surface of the chassis accessory 63b having a Z-shape (step shape), which is projected in a direction vertical to the rear surface of the panel 64 compared with the main surface of the chassis body 63a in the chassis section 63.

In FIG. 9, the buffer plate 80 serving as the buffer member 62 is fabricated from an iron material based on the designing of the thermal expansion coefficient of each constituent element, and the size and thickness thereof are suppressed to the minimum level required for fixing the WB-ADM in order to reduce the deterioration in the thermal conductivity as much as possible. The balance between the sliding mechanism and heat dissipation characteristics is taken by employing the iron material. In this example, the buffer plate 80 can fix the plurality of WB-ADMs 61, has a size, thickness, and outer shape corresponding to the slide in/out mechanism, and comprises the fixing bosses 82 for connection of the aluminum plates 42. The buffer plate 80 is fixed to the fixing bosses 82 by the fixing screws 86.

Note that, when the distortion caused by the temperature increase is not so large, the buffer plate 80 can be made of an aluminum material which is the same material as that of the chassis section 63 as another embodiment. In this case, the buffer plate 80 merely slides as a movable mechanism in terms of position with respect to the surface of the chassis section 63. However, even if there is a structural error between the position of the terminal portion of the panel 64 and the position of the connecting/fixing portion of WB-ADM 61 on the chassis section 63 side, the influence thereof can be absorbed. Moreover, the precision control in designing, manufacturing, assembling of the mechanism structure to these portions is not required to be so strictly carried out, and the cost thereof can be reduced. As a matter of course, the precision control in the connecting operation for connecting the WB-ADMs 61 to terminal portions of the panel 64 and in the screwing operation for fixing to the chassis section 63 side is also not required to be strict, and the effects of the operation time reduction and the assembling performance improvement can be achieved.

In a device assembling step, as shown in FIG. 8A, the buffer plate 80 is inserted in a sliding manner into the chassis accessory 63b. The plurality of WB-ADM 61 are bent and connected via the connection of the terminals of the connectors 83 to the data bus substrate 37 connected to the chassis body 63a. The aluminum plate 42 and the buffer plate 80 are connected and fixed by the fixing screws 86 to the fixing bosses 82 with interposing the flexible substrates 41 of the WB-ADM 61 therebetween.

As shown in FIG. 8B, the buffer plate 80 is attached to a partial area of the chassis accessory 63b at a lower end of the panel 63. On the rear surface side of the panel 63, the sealing resin 45 including the driver IC chip 46 in the WB-ADM 61 is disposed at a distance away from the buffer plate 80.

Further, the buffer member 62 may be merely disposed as a movable mechanism (sliding mechanism) so as to be in contact with the surface of the chassis section 63. Alternatively, the member may be attached thereto by a flexible adhesive. More specifically, the buffer member 62 can be configured to slide in a direction horizontal to a surface of the panel 64 by the flexibility of the adhesive at the time of the temperature increase. Further, the adhesive is desired to have thermal conductivity to the chassis section 63 side in addition to the flexibility.

### Second Embodiment

Next, the second embodiment will be described. A plasma display device of the second embodiment has a configuration comprising a PDP module including the GB-ADM 71, in which a buffer plate 72 having a sliding mechanism with respect to the chassis section 63 is added between the chassis section 63 and the IC chip 56 of the GB-ADM 71A. The driver module (IC chip mounting module) applied in the second embodiment is the same as the above-described GB-ADM 71 shown in FIG. 10.

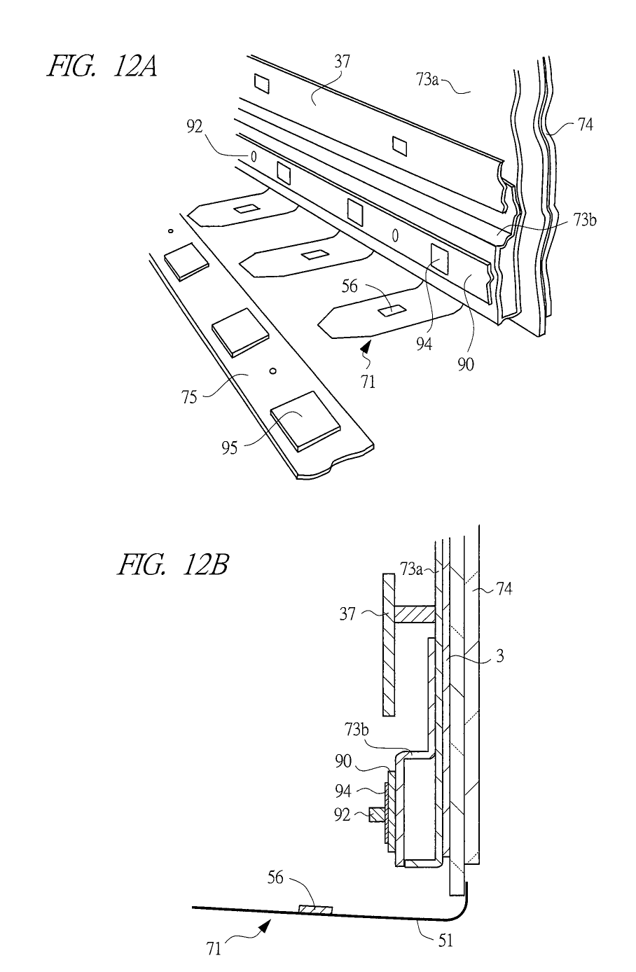

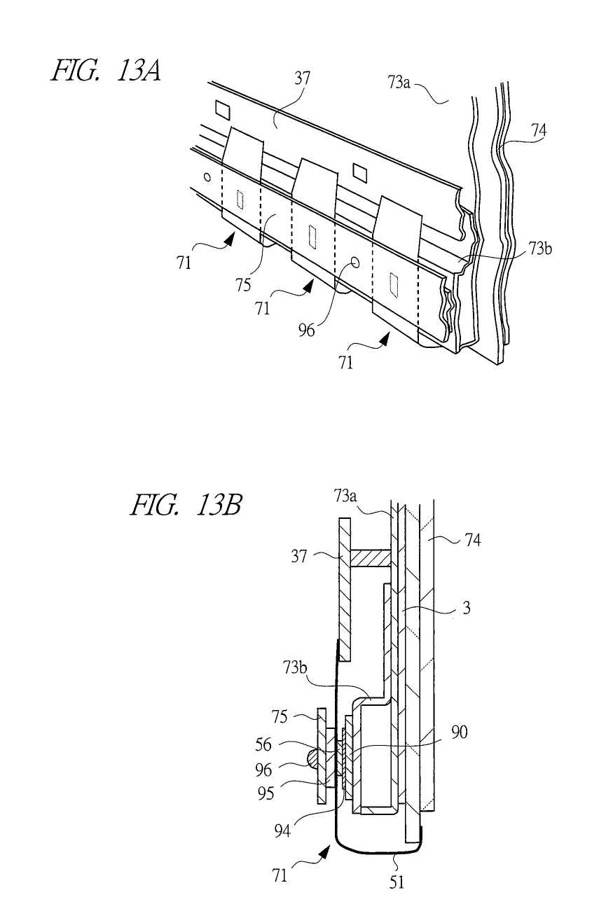

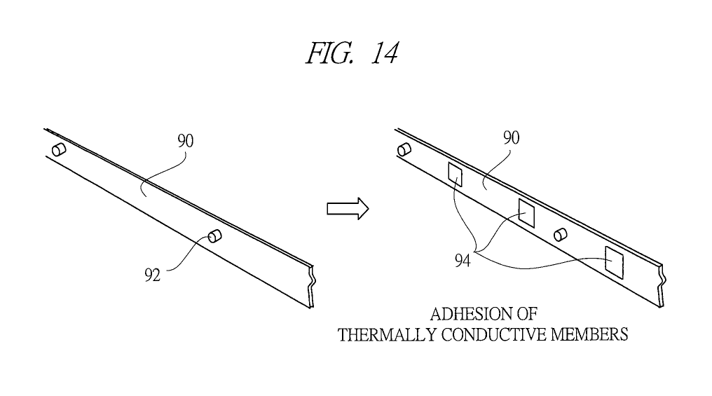

FIG. 11 shows a configuration of main components and principle in the mounting structure of the plasma display device of the second embodiment in the same manner as FIG. 6. Also, FIG. 12A and FIG. 12B and FIG. 13A and FIG. 13B show a specific mounting structure in the second embodiment. FIG. 12A is an external perspective view seen from a rear surface side of a panel before assembling in the mounting structure of the GB-ADM 71. FIG. 12B is a cross-sectional view in a longitudinal direction of the panel corresponding to FIG. 12A. FIG. 13A is an external perspective view seen from a rear surface side of the panel after assembling in the mounting structure of the GB-ADM 71. FIG. 13B is a cross-sectional view corresponding to FIG. 13A. Further, FIG. 14 shows a configuration of a buffer plate 90 in the mounting structure of FIG. 12.

In FIG. 11, sequentially from the device front surface side, the panel 74 (corresponding to the PDP 10), the chassis section 73, the buffer member 72, the GB-ADMs 71, and a holding plate 75 are provided in this order. In this structure, the buffer member 72 is provided between the chassis section 73 and the plurality of GB-ADMs 71.

In this structure, instead of holding the rear surface (non-circuit-formation surface) side of the driver IC chip 56 of the GB-ADM 71 directly on the chassis surface like in the prior-art technology, the rear surface side of the driver IC chip 56 of the GB-ADM 71 is held on the chassis surface with interposing the buffer member 72 therebetween. The buffer member 72 is a mechanism movable also with respect to the holding plate 75 side.

By virtue of the presence of the buffer member 72, direct application of the stress due to the positional shift between the panel 74 and the chassis section 73 to the driver IC chip 56 is buffered, and the problem that the driver IC chip is peeled off can be solved.

The principles of the second embodiment are as follows. With the temperature increase of the panel 74 and the circuit resulting from the circuit power-distribution operation, the temperature of the chassis section 73 also increases and the chassis section 73 thermally expands. Similar to the first embodiment, since the thermal expansion coefficient of the panel (glass material) 74 is smaller than the thermal expansion coefficient of the chassis section (aluminum material) 73, the positional shift occurs as shown by arrows. At this time, in the second embodiment, as shown in the power-on state, sliding occurs between the chassis section 73 and the buffer member 72. Thus, the amount of projection of the GB-ADM 71 pulled by the chassis section 73 is reduced. In other words, the peeling force to the driver IC chip 56 of the flexible substrate 51 is buffered.

FIG. 12A and FIG. 12B show a temporary joint state of the buffer plate 90 as a device assembling step. As the buffer member 72 in the second embodiment, a member having good heat dissipation characteristics with respect to the driver IC chip 56 is required in order to correspond to the GB-ADM 71. Therefore, as the material of the buffer member 72, a material such as a copper material also having good thermal conductivity is desirably used. In this example, the buffer plate 90 made of copper is used as the buffer member 72.

In FIG. 12A and FIG. 14, the buffer plate 90 made of copper is fabricated in advance separately from the chassis section 73. Bosses 92 for fixing the holding plate 75 are provided on the chassis accessory 73b, and holes 93 through which the bosses 92 penetrate are provided in the buffer plate 90. The holes 93 of the buffer plate 90 have an appropriate size in accordance with the positional shift with the chassis. Furthermore, in the buffer plate 90, thermally conductive members 94 are provided for the areas to be in contact with the driver IC chips 56. As the thermally conductive member 94, for example, a thermally conductive resin is applied or a thermally conductive tape is adhered in advance. In the structure of this example, the plurality of thermally conductive members 94 to be in contact with the plurality of IC chips 56 (GB-ADM 71) are adhered onto one buffer plate 90.

Then, as shown in FIG. 12B, in an assembling step, the buffer plate 90 (and the thermally conductive members 94) is interposed between the area of the chassis accessory 73b of the chassis section 73 and the flexible substrates 51 and the driver IC chips 56 of the GB-ADMs 71. Then, as shown in FIG. 13A and FIG. 13B, they are attached so as to be held by the holding plate 75 (and elastic members 95). The elastic members 95 are interposed between the holding plate 75 and the surfaces of the flexible substrates 51 of the GB-ADMs 71 so as to correspond to the positions of the driver IC chips 56. In the holding plate 75, screw holes corresponding to the fixing bosses 92 are formed. The holding plate 75 is fixed by the fixing screws 96 to the fixing bosses 92 of the chassis accessory 73b. The plurality of GB-ADMs 71 are held and fixed by one holding plate 75. In a state where the flexible substrates 51 is bent, the plurality of GB-ADMs 71 are connected to the data bus substrate 37 connected to the chassis body 73a.

By the holding plate 75, the non-circuit-formation surface side of the driver IC chips 56 of the GB-ADM 71 is fixed to the buffer plate 90 on the chassis accessory 73b via the thermally conductive member 94. Also, the surface on the opposite side of the mounting surface of the driver IC chip 56 of the GB-ADM 71 is held by the holding plate 75 via the elastic members 95.

Also in the second embodiment, similar to the first embodiment, the buffer plate 90 can be made of an aluminum material which is the same material as that of the chassis section 73. In this case, the operation of applying or adhering the thermally conductive members 94 to the chassis section 73 side is required only for the buffer plate 90 separated as another member. Therefore, this operation can be performed separately from the manufacturing step of the chassis 1 and the assembling step of the display device. Therefore, the applying or adhering operation can be intensively performed. Further, since the attachment can be performed on the small buffer member 72 instead of the large chassis 1, the simplification and efficiency improvement of the operation can be achieved.

Particularly, when a type of resin which is applied by printing is used as the thermally conductive resin serving as the thermally conductive members 94, since the operation is intensively performed by using printing equipment, the application of the structure of the second embodiment exerts a significant effect of improving the efficiency of the operation.

When an emphasis is placed on the simplification and efficiency improvement of the operation of applying or adhering the thermally conductive members 94 to the buffer plate 90 as described above and when the screen size of the display is relatively small and the above-described positional shift problem caused by the temperature increase is small, the attachment structure of the buffer plate 90 to the chassis section 73 side does not have to have the mutually movable structure. For example, a structure in which the buffer plate is fixed by screwing to the chassis section 73 can be employed.

As described above, when the buffer plate 90 is fixed by screwing to the chassis section 73, by providing the fixing bosses 92 on the buffer plate 90 side, a structure in which the holding plate 75 is fixed to the buffer plate 90 side by screwing can be employed.

The size of the buffer member (62, 72) in the above-described first and second embodiments is effective even in the configuration in which one member thereof is provided in a plasma display device. Also, when the buffer member is divided into plural pieces, in other words, when a plurality of buffer plates are disposed so as to correspond to each of the ADMs, the effect that each of the buffer plate is movable individually in accordance with the dividing number thereof and the effect that the expansion size thereof is reduced in accordance with the reduction in size can be simultaneously obtained, and still larger effect can be expected. Therefore, when the chassis 1 is made of an aluminum plate in the above-described structure in which the buffer member is divided and disposed, similar effects can be expected even when the same aluminum plate material is used as the buffer member.

### Third Embodiment

Next, the third embodiment will be described. Similar to the second embodiment, the third embodiment shows a mounting structure with respect to the GB-ADM 71. In the structure of the second embodiment, the buffer member 72 is attached so as to be interposed by the surface of a part of the chassis section 73. On the other hand, in the structure of the third embodiment, the buffer member 72 is attached so that it is embedded in a groove-shaped area portion formed in a part of the chassis accessory 73b in the chassis section 73. For example, in this structure, it can be slid in and out like in the first embodiment. Other portions are the same as those of the second embodiment.

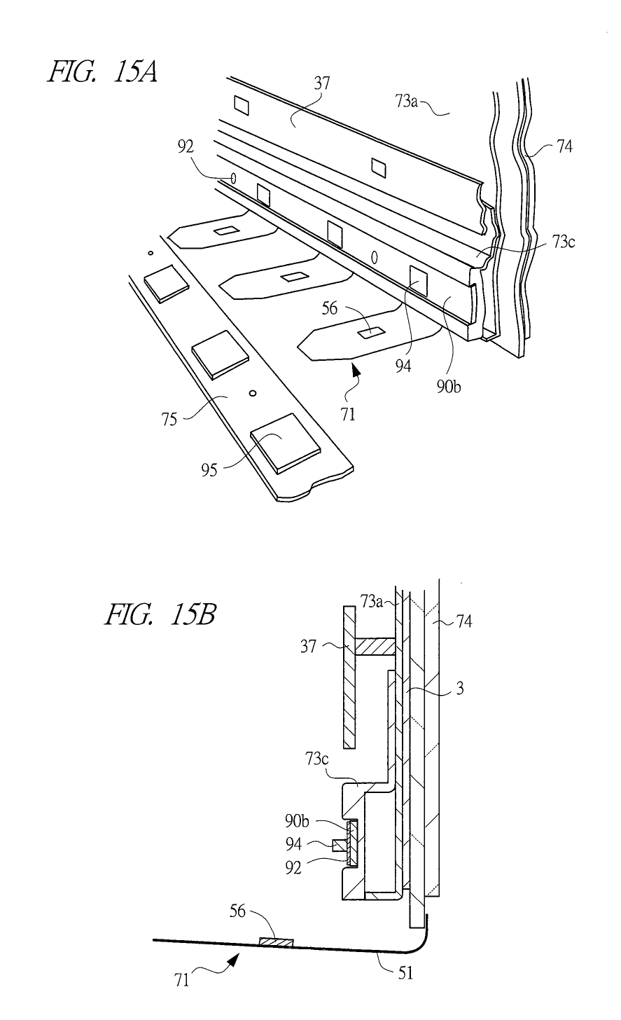

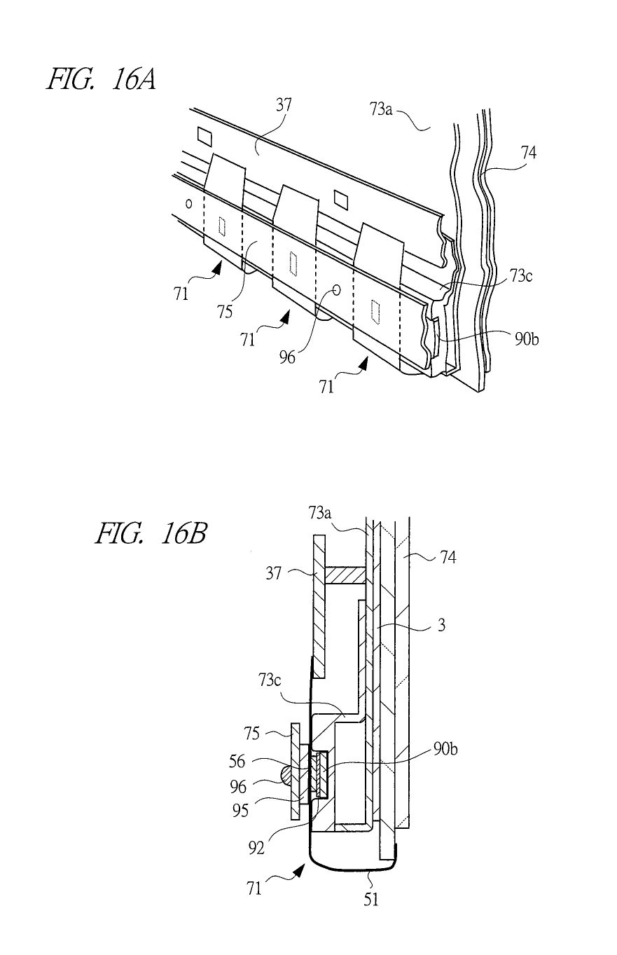

In the mounting structure of a plasma display device of the third embodiment, the configuration of main components and principle are the same as those of the second embodiment. Also, FIG. 15A and FIG. 15B and FIG. 16A and FIG. 16B show a specific mounting structure in the third embodiment in the same manner as that of the above-described second embodiment. FIG. 15A and FIG. 15B show the state before assembling, and FIG. 16A and FIG. 16B show the state after assembling. Further, the configuration of a buffer plate 90b in the mounting structure of the third embodiment is approximately the same as that shown in FIG. 14 and corresponds to a slide-type mechanism.

The depth of a groove-shaped area portion in which the buffer plate 90b is embedded is determined in consideration of the thickness of the driver IC chip 56 in addition to that of the buffer plate 90b, and it is designed in consideration that excessive stress is not applied to the driver IC chips 56 when the GB-ADMs 71 are held by the holding plate 75.

Also in the above-described second and third embodiments, as a matter of course, in addition to iron or copper having a small thermal expansion coefficient, various alloys described in the first embodiment and, depending on conditions, the same material as that of the chassis material (for example, aluminum) can be used as the material of the buffer member.

As described above, according to the embodiments, in the plasma display device, by the mounting structure of the driver IC chips for driving the electrodes (X, Y, A) of the PDP 10, the failure occurrence caused by the temperature increase of the PDP 10 and the chassis 1 can be suppressed, and also the load to the flexible substrates and driver IC chips of the ADMs can be buffered. Therefore, quality stable in terms of long-term reliability can be obtained. Moreover, since the buffer member is particularly taken into consideration also as heat dissipation means, the heat dissipation performance of the device is excellent, low-cost and high-density mounting can be achieved in the case of the GB-ADM 71, and high-density mounting can be achieved also in the case of the WB-ADM 61.

Note that, although a plasma display panel (PDP) has been taken as the flat display panel (FDP) in the detail description of the embodiments above, based on the principles and configuration, the present invention can be applied to other FDPs such as a liquid-crystal display panel and an EL display panel as a matter of course.

Moreover, as another embodiment, although the description of the embodiments above has been made for ADMs for driving address electrodes, the present invention can be applied to other driver modules for driving electrodes such as scanning electrodes in the same manner.

### INDUSTRIAL APPLICABILITY

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention can be used for a module including a panel, a chassis and a driver module and for a display device including the module such as a plasma display device.

1. A flat display device comprising:
a flat display panel having an electrode;
a driver module having a driver IC chip connected to the electrode of the flat display panel to drive the electrode and a flexible substrate having the driver IC chip mounted thereon;
a chassis section provided near a rear surface side of the flat display panel; and
a buffer member attached so as to be movable with respect to the chassis section,
wherein the driver module is fixed to the buffer member.

2. The flat display device according to claim 1,
wherein the buffer member is attached so as to have a sliding mechanism with respect to the chassis section.

3. The flat display device according to claim 2,
wherein the buffer member includes a buffer plate, and
the sliding mechanism is configured by providing a groove-shaped member in a surface of the chassis section on a driver module side, and attaching the buffer plate into a groove-shaped area of the groove-shaped member so as to be slidable.

4. The flat display device according to claim 3,
wherein the driver module has a fixing plate on a surface opposite to the chassis section, a screw hole is provided in the fixing plate, and a fixing boss is provided at a position of the buffer plate corresponding to the screw hole, and
the fixing plate is configured to be fixed by a fixing screw to the fixing boss.

5. The flat display device according to claim 1,
wherein the buffer member is configured to include a buffer plate attached to the chassis section by a flexible adhesive.

6. The flat display device according to claim 5,
wherein the buffer plate is made of a material having good thermal conductivity.

7. The flat display device according to claim 5,
wherein the adhesive is made of a material having good thermal conductivity.

8. The flat display device according to claim 1,
wherein the buffer member has a value of thermal expansion coefficient close to a value of thermal expansion coefficient of the flat display panel rather than that of the chassis section.

9. The flat display device according to claim 1,
wherein the flat display panel is a plasma display panel, and
the driver module is a module for driving an address electrode of the plasma display panel.

10. A flat display device comprising:
a flat display panel having an electrode;
a driver module having a driver IC chip connected to the electrode of the flat display panel to drive the electrode and a flexible substrate having the driver IC chip mounted thereon;
a chassis section provided near a rear surface side of the flat display panel;
a holding plate holding the driver module by applying a pressing force to the driver module by a direct or indirect combination with the chassis section; and
a buffer member formed separately from the chassis section and the holding plate,
wherein the buffer member is disposed near a non-circuit-formation surface of the driver IC chip.

11. The flat display device according to claim 10,
wherein the buffer member is movable with respect to the chassis section and the holding plate.

12. The flat display device according to claim 11,
wherein the buffer member is configured to be attached so as to have a sliding mechanism with respect to the chassis section and the holding plate and so as to be movable with respect to the chassis section and the holding plate.

13. The flat display device according to claim 12,
wherein the buffer member is configured to include a buffer plate, and
the sliding mechanism is configured by providing a groove-shaped member in a surface of the chassis section on a driver module side, and attaching the buffer plate into a groove-shaped area of the groove-shaped member so as to be slidable.

14. The flat display device according to claim 11,
wherein the buffer member is configured to include a buffer plate attached to the chassis section by a flexible adhesive so as to be movable with respect to the chassis section and the holding plate.

15. The flat display device according to claim 14,
wherein the buffer plate is made of a material having good thermal conductivity.

16. The flat display device according to claim 14,
wherein the adhesive is made of a material having good thermal conductivity.

17. The flat display device according to claim 10,
wherein the buffer member has an area in which a thermally conductive member is provided, and the buffer member presses the driver module by the area.

18. The flat display device according to claim 10,
wherein the holding plate has an area in which an elastic member is provided, and the holding plate is arranged so that a non-circuit-formation surface of the driver IC chip is disposed near the area.

19. The flat display device according to claim 10,
wherein the buffer member has a value of thermal expansion coefficient close to a value of thermal expansion coefficient of the flat display panel rather than those of the chassis section and the holding plate.

20. The flat display device according to claim 10,
wherein the flat display panel is a plasma display panel, and
the driver module is a module for driving an address electrode of the plasma display panel.
